(19) United States
(12) Patent Application Publication
(10) Pub. No.: US 2018/0077705 A1
(43) Pub. Date: Mar. 15, 2018

(54) COMMUNICATION APPARATUS, COMMUNICATION METHOD, AND STORAGE MEDIUM

(71) Applicant: CANON KABUSHIKI KAISHA, Tokyo (JP)

(72) Inventor: Hitoshi Aoki, Kawasaki-shi (JP)

(21) Appl. No.: 15/701,983

(22) Filed: Sep. 12, 2017

(30) Foreign Application Priority Data
Sep. 15, 2016 (JP) 2016-180634

(51) Int. Cl. H04W 72/04; H04W 56/00

(52) U.S. Cl. CPC H04W 72/0446; H04W 88/182; H04W 56/0015

(57) ABSTRACT

A communication apparatus transmits or receives wireless signals in a period with a predetermined length and occurring at a predetermined time interval, processes at least one of transmission or reception of a wireless signal in the period as a proxy of a specific communication apparatus belonging to a group of communication apparatuses that are in synchronization during the period, and decides, based on whether a period in which proxy processing is performed is a period in which the specific communication apparatus transmits or receives wireless signals.

### BACKGROUND

### Field

The present disclosure relates to a communication technology.

### Description of the Related Art

In recent years, wireless local area networks (LANs) represented by wireless networks compliant with Institute of Electrical and Electronics Engineers (IEEE) 802.11 standard series have been widely used. In many cases, a wireless LAN is controlled by a base station called an access point (AP). A wireless network includes an AP and stations (STAs) that are present within the electric wave coverage of the AP and in a wireless connection state.

In addition to such a conventional simple wireless network configuration including an AP and STAs, various network forms have been devised for the wireless LANs. Products and specification standards of such various network forms have appeared. US Patent Application Publication No. 2014/0302787 discusses Neighbor Awareness Networking (NAN), defined by Wi-Fi Alliance® as a standard for discovering a communication apparatus and a service provided by the communication apparatus in a power saving way.

This intends to save power by causing a communication apparatus to reduce a period for enabling a wireless radio frequency (RF) unit. The communication apparatus reduces this period by synchronizing with another communication apparatus during a period for exchanging information with another communication apparatus. This period for the synchronization in the NAN is called a discovery window (DW). A group of NAN devices sharing a predetermined synchronization period is called a NAN cluster. Among the NAN devices, a terminal having a role called Master and a terminal having a role called Non-Master Sync each transmit a synchronization beacon (hereinafter referred to as synch beacon). The synch beacon is a signal for ensuring synchronization between terminals during a DW.

A NAN device transmits and receives messages, such as a subscribe message and a publish message, during a DW, after establishing synchronization with another terminal. The subscribe message is a signal for discovering a service, and the publish message is a signal for notifying provision of a service. The NAN device can transmit and receive follow-up messages for exchanging additional information about a service during a DW. The NAN device can enter a doze state, in which the NAN device receives no wireless signal, during some DWs. This can further reduce power consumption.

How often, among DWs, a NAN device receives wireless signals depends on the NAN device. However, each NAN device participating in a NAN cluster needs to be in a wireless signal receivable state (hereinafter may be referred to as an awake state) in a special DW called DW0. DW0 is a DW that repeats every sixteen DW intervals. In addition, DW0 starts at a time when the lower-order 23 bits of a time synchronization function (TSF) are 0x0. The TSF is a counter timer used by the NAN cluster for synchronization. NAN devices operating as a Master and a Non-Master Sync need to transmit a synch beacon during every DW, Thus, these NAN devices can receive wireless signals during all DWs. A NAN device not transmitting a synch beacon during every DW operates as a Non-Master Non-Sync. This NAN device does not need to be in the awake state during all DWs. This NAN device can be in the awake state at the very least during DW0.

There has been discussed a method that a communication apparatus discovers a service of a communication apparatus present in an area outside its own wireless-signal coverage, or allows itself to be discovered, by requesting another communication apparatus to search for or provide a service. According to US Patent Application Publication No. 2015/0081840, a communication apparatus requested to serve as a proxy (hereinafter may be referred to as a proxy server) is notified of information about a service provided by a communication apparatus requesting the proxy service (hereinafter may be referred to as a proxy client).

When being requested to serve as the proxy, the proxy server notifies the presence of a service in response to an inquiry about the service from another communication apparatus, by acting as the proxy of the proxy client. In this process, another communication apparatus is notified of information about the service and a period in which the proxy client is awake. Thus, another communication apparatus can detect the presence of the service, based on the notified information. In a case where another communication apparatus is at a distance enabling communication with the proxy client, this communication apparatus can discover a service, by notifying the proxy client of a message in a period in which the proxy client is awake.

Assume that another NAN device transmits a subscribe message or a publish message in a period in which the proxy client requesting the proxy service can perform wireless communication. In this case, both the proxy server and the proxy client can respond. Although the DW is an extremely short communication period corresponding to 16 traffic units (TU), a wireless bandwidth is wasted if NAN devices provide duplicate responses.

### SUMMARY OF THE INVENTION

The present disclosure is directed to a technology for using a wireless bandwidth with enhanced efficiently.

According to an aspect of the present disclosure, a communication apparatus includes a communication unit configured to transmit or receive wireless signals in a period with a predetermined length and occurring at a predetermined time interval, a processing unit configured to process at least one of transmission or reception of a wireless signal in the period as a proxy of a specific communication apparatus belonging to a group of communication apparatuses that are in synchronization during the period, and a decision unit configured to decide, based on whether a period in which the processing unit performs the proxy processing is a period in which the specific communication apparatus transmits or receives wireless signals, whether to perform proxy processing by the processing unit.

Further features will become apparent from the following description of exemplary embodiments with reference to the attached drawings.

### BRIEF DESCRIPTION OF THE DRAWINGS

FIG. 1 is a diagram illustrating a configuration example of a wireless communication system.

FIG. 2 is a block diagram illustrating a function configuration example of a NAN device.

FIG. 3 is a block diagram illustrating a hardware configuration example of the NAN device.

FIG. 4 is a flowchart illustrating an example of proxy response processing.

FIG. 5 is a sequence diagram illustrating an example of a processing procedure of proxy request processing.

FIG. 6 is a sequence diagram illustrating an example of a processing procedure in which a proxy client directly responds during a DW0.

FIG. 7 is a sequence diagram illustrating an example of a processing procedure in which the proxy client is a beaconing device and directly responds.

FIG. 8 is a sequence diagram illustrating an example of a processing procedure in which proxy registration is cancelled in a case where the proxy client gives no response.

FIGS. 9A and 9B each illustrate an example of a relationship between DWs and signal transmission/reception timings.

### DESCRIPTION OF THE EMBODIMENTS

An exemplary embodiment will be described below by way of example, with reference to the drawings. In the following description, communication apparatuses are each assumed to be a terminal having a communication function for a wireless LAN in conformity with the IEEE 802.11 standard series. However, each of the communication apparatuses is not limited thereto. In addition, the following communication apparatuses are each assumed to be a NAN device that can discover another communication apparatus and a service provided thereby, via Wi-Fi® NAN. However, each of the following communication apparatuses is not limited thereto. In other words, although technical terms corresponding to a predetermined standard are used in each part of the following description, each of the following discussions is applicable to other similar types of standard.

The NAN will now be described. In the NAN, service information is communicated during a DW. The DW is a period corresponding to a time and a channel in which devices executing the NAN converge. A group of terminals sharing a DW schedule is referred to as a NAN cluster.

Each of the terminals belonging to the NAN cluster operates as any one of a Master, a Non-Master Sync, and a Non-Master Non-Sync. The terminal operating as the Master transmits a synch beacon, which is a beacon for enabling each of the terminals to distinguish a DW for synchronization. The terminal operating as the Master transmits a discovery beacon, which is a signal for allowing a terminal not belonging to the NAN cluster to recognize the NAN cluster. The discovery beacon is also transmitted in a period other than DWs. For example, the discovery beacon is transmitted every 100 TU (1 TU is equal to 1024 microseconds). In each of NAN clusters, at least one terminal operates as the Master. The terminal operating as the Non-Master Sync transmits the synch beacon, but does not transmit the discovery beacon. The terminal operating as the Non-Master Non-Sync transmits neither the synch beacon nor the discovery beacon.

How likely a terminal is to be each of the Master, the Non-Master Sync, and the Non-Master Non-Sync is decided based on a Master Rank defined by the NAN standard. Specifically, based on a Master Preference set for each of NAN devices, a Random Factor that is a random value, and a media access control (MAC) of an interface address, the Master Rank is decided by the following expression: Master Rank=Master Preference*2̂56+Random Factor*2̂48+MAC[5] *2̂40+ . . . +MAC[0].

A NAN device having a higher Master Rank is more likely to have a role as the Master. A NAN device having a lower Master Rank is more likely to have a role as the Non-Master Non-Sync. In particular, a NAN device having the highest Master Rank in a NAN cluster is called an Anchor Master, and serves as a time reference in the NAN cluster. In the NAN standard, it is recommended that, for example, a NAN device, which is constantly participating in a NAN cluster and immovable as being driven by a commercial power supply, have a higher Master Rank. It is also recommended that a NAN device, which is driven by a battery or unlikely to be stably present in a NAN cluster, such as a mobile terminal, have a lower Master Rank. If a NAN device that stably remains is the Master and transmits synchronization signals, a NAN cluster can be stably maintained.

Terminals participating in a NAN cluster are in synchronization during a DW coming in a predetermined interval, according to a synch beacon, and communicates service information during the DW. The terminals communicate a subscribe message and a publish message to each other. The subscribe message is a signal for discovering a service during a DW. The publish message is a signal for notifying that a service is provided. Each of the terminals can exchange follow-up messages for exchanging additional information about the service during a DW. The messages, such as the publish message, the subscribe message, and the Follow-up message, may be collectively referred to as a service discovery frame (SDF). Each of the terminals can perform advertisement or detection of a service by exchanging the SDFs.

As described above, a NAN device can reduce power consumption during a DW as well by entering a doze state in which no wireless signal is transmitted and received. However, such a NAN device cannot transmit and receive a subscribe message and a publish message during a DW in which the NAN device is in the doze state. For this reason, a period until another NAN device discovers a service provided by the NAN device can be prolonged.

In response, some NAN device can request another NAN device to perform service search and notification using messages, such as a subscribe message and a publish message. Here, a specific NAN device, which performs proxy processing for searching for a service and notifying a service for another NAN device, is referred to as a proxy server. A specific NAN device, which requests another NAN device to perform proxy processing, is referred to as a proxy client.

When being requested by the proxy client to act as a proxy and transmit service information as the proxy, the proxy server transmits the service information of the proxy client. Since the proxy server executes service search and notification as the proxy of the proxy client, the proxy client can greatly reduce power consumption by entering a doze state for a prolonged period. In addition, even if a NAN device searching for a service provided by the proxy client transmits a subscribe message when the proxy client is in the doze state, this NAN device can receive a response from the proxy server. Since the proxy server responds as the proxy even if the proxy client is in the doze state, the NAN device searching for a service is more likely to be able to discover the service provided by the proxy client.

If the proxy server executes service search and notification as the proxy even though the proxy client can execute such service search and notification, duplicate messages are transmitted. As a result, a wireless bandwidth is wasted, which can reduce efficiency of use of the wireless bandwidth. Therefore, in the present exemplary embodiment, the NAN serving as the proxy server detects a timing at which the proxy client can respond to a service search or notification. When detecting the timing at which the proxy client can respond, the proxy server does not respond as the proxy. The proxy server is controlled to respond only at a timing that is not the timing when the proxy client can respond.

A configuration of each of a wireless communication system and a communication apparatus that are common to exemplary embodiments will be described first. A flow of processing according to each of the exemplary embodiments will be subsequently described.

### (Configuration of Wireless Communication System)

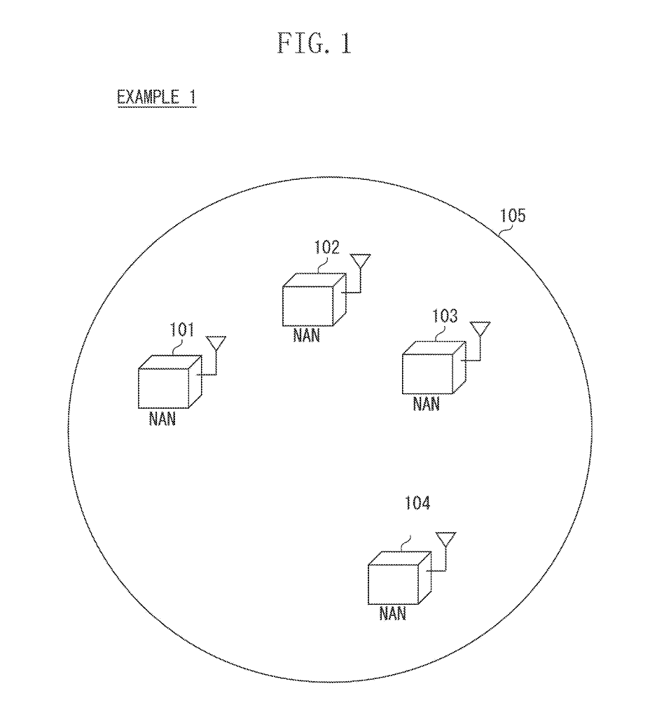

First, a configuration example of a wireless communication system according to an exemplary embodiment will be described with reference to FIG. 1. The wireless communication system according to the present exemplary embodiment includes NAN devices 101, 102, 103, and 104. Each of the NAN devices 101 to 104 is a communication apparatus in conformity with the NAN standard. The NAN devices 101 to 104 participate in a NAN cluster 105. The NAN devices 101 to 104 participating in the NAN cluster 105 implement a network at a frequency channel 6 (6 ch).

Here, in the NAN cluster 105, the length of a DW is 16 TU, and a time interval between the start timing of a DW and the start timing of the next DW is 512 TU. One cycle includes DWs of DW0 to DW15 and sixteen DW intervals. After DWn (“n” is an integer of 0 to 15) with sixteen DW intervals is followed by, again, DWn. Each of the NAN devices participating in the NAN cluster 105 is in an awake state in DW0 without fail, and can receive a wireless signal in DW0.

The NAN device 101 is a communication apparatus that executes each step of processing to be described below. Based on the NAN standard, the NAN device 101 can discover neighboring communication apparatuses and services provided by these apparatuses. The NAN device 101 can also provide information of a service that the NAN device 101 can provide. In addition, the NAN device 101 can operate as a proxy server that acts as a proxy that searches for a service and notifies a service of another NAN device. The NAN device 101 is assumed to be a Non-Master Non-Sync, but the NAN device 101 can perform wireless transmission and reception during all the DWs.

The NAN device 102 is a communication apparatus participating in the NAN cluster 105 as a Non-Master Non-Sync. The NAN device 102 also includes a function of being a printer, and notifies a print service to other NAN devices. The NAN device 102 includes a function of being a proxy client. When discovering a proxy server, the NAN device 102 can request the proxy server to act as a proxy and notify the service. In a case where the NAN device 102 notifies a service by itself, i.e., in a case where the NAN device 102 makes no proxy request, the NAN device 102 receives wireless signals during all the DWs. In a case where the NAN device 102 makes a proxy request, the NAN device 102 receives wireless signals only during DW0.

The NAN device 103 is a communication apparatus participating in the NAN cluster 105, as a Non-Master Non-Sync. The NAN device 103 searches for a print service, based on an instruction of a user (not illustrated) of the NAN device 103. In other words, the NAN device 102 is a publisher that provides a predetermined service, which is searched for by the NAN device 103. The NAN device 103 is assumed to be a subscriber that searches for the predetermined service notified by the NAN device 102.

The NAN device 104 is a Master that participates in the NAN cluster 105. Each of the NAN devices 101 to 104 is assumed to enter the doze state in which no power is supplied to a communication unit, during a DW in which no wireless signal is transmitted and received.

### (Configuration of NAN Device 101)

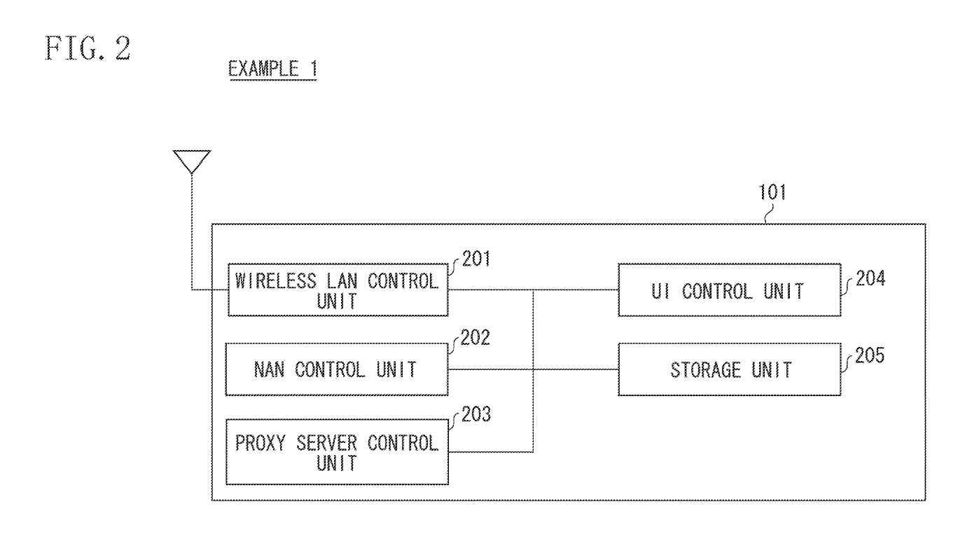

FIG. 2 is a block diagram illustrating a function configuration example of the NAN device 101. The NAN device 101 includes, for example, a wireless LAN control unit 201, a NAN control unit 202, a proxy server control unit 203, a user interface (UI) control unit 204, and a storage unit 205, as a functional configuration thereof.

The wireless LAN control unit 201 includes an antenna as well as a circuit for transmitting and receiving wireless signals to and from other wireless LAN devices. The wireless LAN control unit 201 also includes a program for controlling the antenna and circuit. The wireless LAN control unit 201 executes communication control for a wireless LAN, according to the IEEE 802.11 standard series. The NAN control unit 202 includes a program and hardware for performing control according to the NAN standard.

The proxy server control unit 203 controls the NAN control unit 202 to implement a proxy function of searching for a service and notifying a service of other NAN devices while serving as a proxy. The UI control unit 204 includes hardware for user interface including a touch panel and buttons for receiving operation performed on the NAN device 101 by a user (not illustrated) of the NAN device 101. The UI control unit 204 also includes a program for controlling the user interface and a function for presenting information to the user. Examples of this information include images and audio outputs. The storage unit 205 can be configured of memories, such as a read only memory (ROM) and a random access memory (RAM), for storing a program and data for operation of the NAN device 101.

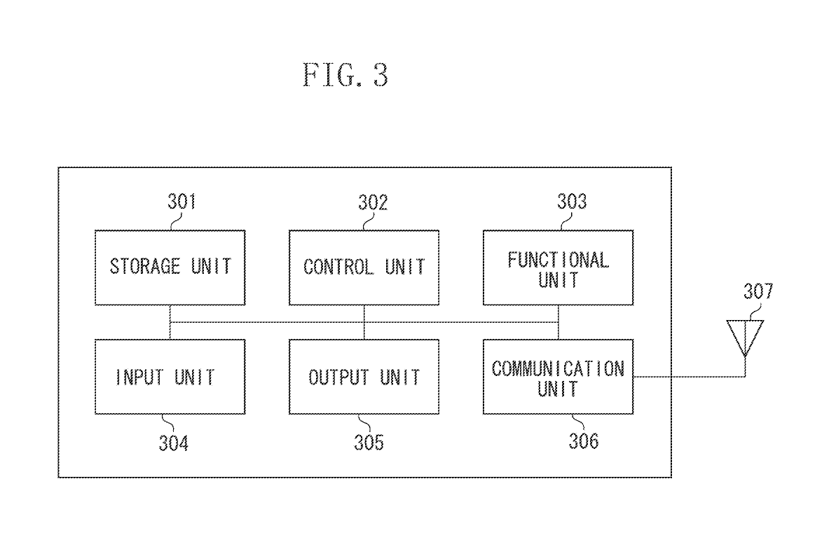

FIG. 3 illustrates a hardware configuration of the NAN device 101 according to the present exemplary embodiment. The NAN device 101 includes a storage unit 301, a control unit 302, a functional unit 303, an input unit 304, an output unit 305, a communication unit 306, and an antenna 307, as an example of the hardware configuration. The storage unit 301 is configured of a ROM or a RAM or both. The storage unit 301 stores a program for performing various kinds of operations described below. The storage unit 301 also stores various kinds of information, such as communication parameters for wireless communication. Besides memories, such as a ROM and a RAM, other types of storage medium can be used for the storage unit 301. Examples of other types of storage medium include a flexible disk, a hard disk, an optical disk, a magneto-optical (MO) disk, a compact disc read only memory (CD-ROM), a CD recordable (CD-R), a magnetic tape, a nonvolatile memory card, and a digital versatile disc (DVD).

The control unit 302 is configured of one or more central processing units (CPUs), or a micro-processing unit (MPU). The control unit 302 controls the NAN device 101 by executing a program stored in the storage unit 301. The control unit 302 can control the NAN device 101 based on collaboration between a program stored in the storage unit 301 and an operating system (OS).

The control unit 302 also executes predetermined processing, such as imaging, printing, and projecting, by controlling the functional unit 303. The functional unit 303 is hardware provided for the NAN device 101 to execute predetermined processing. For example, in a case where the NAN device 101 is a camera, the functional unit 303 is an imaging unit and performs imaging processing. In a case where the NAN device 101 is, for example, a printer, the functional unit 303 is a print unit and performs print processing. In a case where the NAN device 101 is, for example, a projector, the functional unit 303 is a projection unit and performs projection processing. Data to be processed by the functional unit 303 can be data stored in the storage unit 301, or can be data resulting from communication with other communication apparatus via the communication unit 306 described below.

The input unit 304 receives various kinds of operation from the user. The output unit 305 provides various outputs for the user. Here, the outputs by the output unit 305 include at least one of display on a screen, an audio output by a speaker, and a vibration output. The input unit 304 and the output unit 305 can be combined and implemented as a single module, such as a touch panel.

The communication unit 306 controls wireless communication in conformity with the IEEE 802.11 standard series, and controls the Internet Protocol (IP) communication. The communication unit 306 transmits and receives wireless signals for wireless communication by controlling the antenna 307. The NAN device 101 communicates with other communication apparatuses via the communication unit 306 for information such as image data, document data, and video data.

### (Procedure of Processing)

Next, a procedure of processing executed by the NAN device 101 described above and a sequence in the wireless communication system will be described.

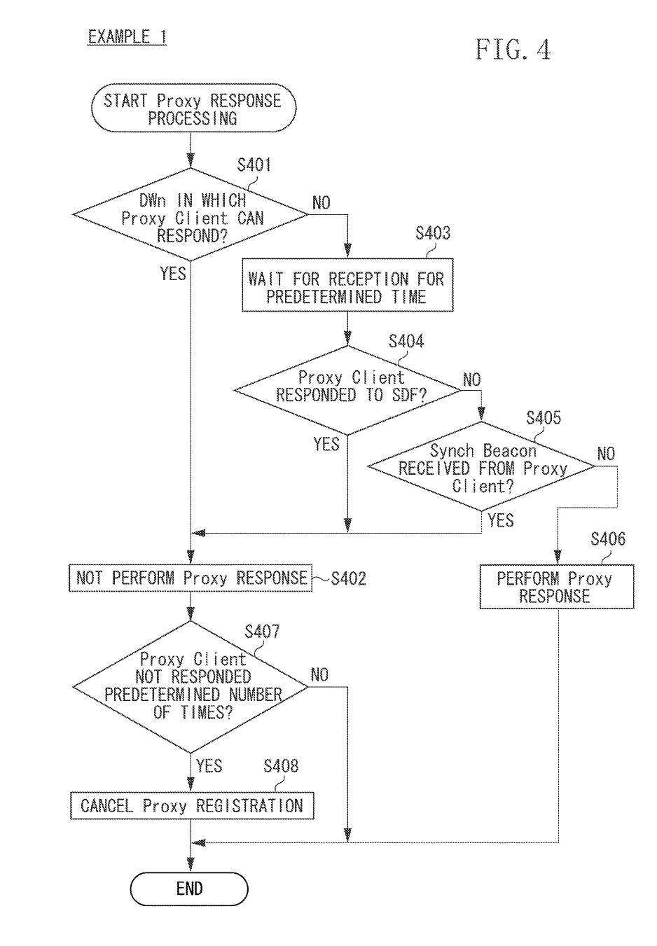

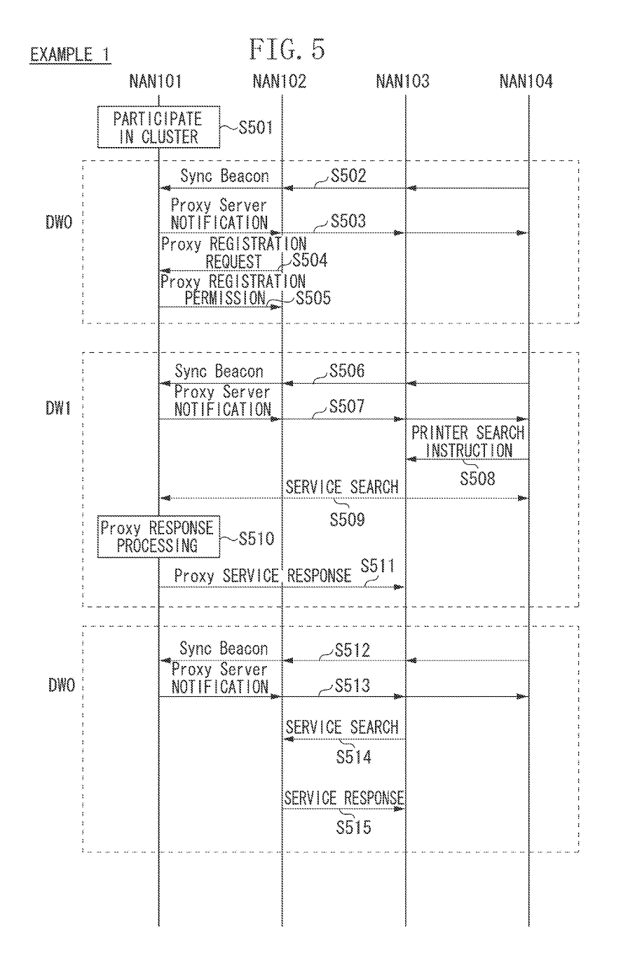

FIG. 4 is a flowchart illustrating processing executed in the NAN device 101 of the present exemplary embodiment. This processing beings when the NAN device 101 receives a message searching for a service after receiving a proxy request for notification of the service. The flowchart illustrated in FIG. 4 represents a procedure of processing performed by the control unit 302 of the NAN device 101. The control unit 302 performs this processing by reading a computer program stored in the storage unit 301, and then executing the computer program. Some or all of steps of the flowchart illustrated in FIG. 4 can be implemented by hardware, such as an application specific integrated circuit (ASIC). The processing of the flowchart illustrated in FIG. 4 will be described below with reference to a sequence diagram illustrated in each of FIGS. 5 to 8.

FIG. 5 illustrates a sequence diagram in a case where the NAN device 101 receives a proxy request from the NAN device 102. Assume that, at the beginning of processing illustrated in FIG. 5, the NAN device 101 has not received a request for proxy transmission from other NAN devices and has not been operating as a proxy server. In addition, assume that the NAN device 102, the NAN device 103, and the NAN device 104 participate in the NAN cluster 105, as illustrated in FIG. 1.

First, in step S501, when the user of the NAN device 101 starts the NAN device 101, the NAN device 101 discovers the NAN cluster 105 and participates in the NAN cluster 105. In step S502, upon start of DW0, the NAN device 104 operating as the Master transmits a synch beacon based on the NAN specifications to notify that the current period is a DW. In step S503, the NAN device 101 transmits a publish message during the DW to notify that the NAN device 101 has a function of a proxy server.

In step S504, upon receipt of the publish message transmitted in step S503, the NAN device 102 discovers the proxy server. Then, the NAN device 102 transmits a proxy registration request to the NAN device 101 in order to request the NAN device 101 to serve as a proxy and notify a service. In this process, after requesting such proxy processing, the NAN device 102 informs the NAN device 101 of a DW in which the NAN device 102 is awake, among DW0 to DW15. In this example, the NAN device 102 is awake only during DW0, upon completion of making a proxy request.

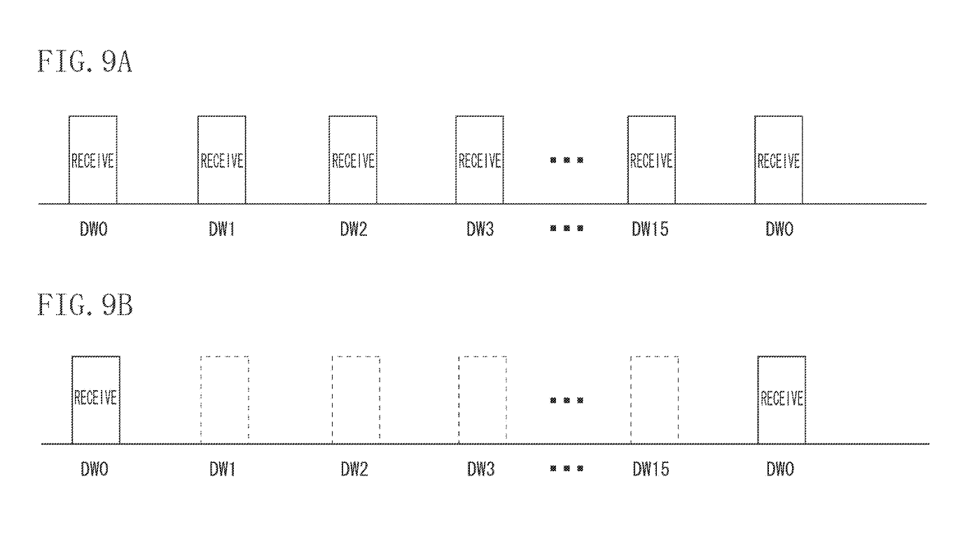

More specifically, the NAN device 102 shifts from a state that the NAN device 102 is awake during all the DWs, as illustrated in FIG. 9A, to a state that the NAN device 102 is awake only during DW0 while being in the doze state during the other DWs, as illustrated in FIG. 9B. In the proxy registration request, the NAN device 102 notifies the NAN device 101 that the NAN device 102 can provide a print service. The NAN device 101 acquires contents of a service provided by the proxy client and information indicating a DW in which the proxy client can transmit and receive a wireless signal among DWs by receiving the proxy registration request.

In step S505, upon receipt of the proxy registration request transmitted in step S504, the NAN device 101 transmits a message notifying that the proxy registration is complete. After that, when receiving a subscribe message for searching for a print service, the NAN device 101 returns a message notifying that the NAN device 102 provides the print service as a response. This response includes information indicating that the NAN device 102 is awake during DW0. The NAN device 101 thus serves as a proxy of the NAN device 102 and performs service notification. The message for notifying that the NAN device 102 provides the print service and is awake during DW0 will be hereinafter referred to as “proxy service notification”. This message is transmitted as a publish message.

In step S506, during the next DW that is DW1, the NAN device 104 serving as the Master transmits a synch beacon. In step S507, the NAN device 101 notifies a publish message that the NAN device 101 has the function of the proxy server. Here, a proxy service notification for the NAN device 102 can be broadcasted. Next, in step S508, the user of the NAN device 103 instructs the NAN device 103 to search for a printer. Then, in step S509, the NAN device 103 transmits a subscribe message to search for a print service.

In step S510, upon receiving a subscribe message for searching for a service matching with the service corresponding to the proxy request, the NAN device 101 performs the processing of the flowchart in FIG. 4 to execute response processing. In this example, the NAN device 101 receives the proxy request for the print service from the NAN device 102. Therefore, the processing illustrated in FIG. 4 starts when the NAN device 101 receives a subscribe message for searching for a print service.

First, in step S401, the NAN device 101 determines whether the current DW is DWn in which a proxy client can respond. In the example illustrated in FIG. 5, DWn in which the proxy client can respond is DW0 notified in step S504. In DW0, the NAN device 102 is awake. The DW at the time in step S509 is DW1 and therefore, the NAN device 101 determines that the current DW is not DWn in which the proxy client can respond (NO in step S401). The processing then proceeds to step S403. In step S403, the NAN device 101 waits for reception for a predetermined time.

After waiting for receipt for the predetermined time, the NAN device 101 determines, in step S404, whether the proxy client has responded to a subscribe message (transmitted in step S509) during this DW. Specifically, the NAN device 101 performs this step as follows. The NAN device 101 stores address information of the proxy client (in this example, the NAN device 102) of which proxy registration has been done. For this proxy client, the proxy registration has been made in the NAN device 101. The NAN device 101 checks the source address of a message transmitted during the DW, and receives this message if the checked address is the address of the proxy client. The NAN device 101 then determines whether this message is a response message to the subscribe message transmitted in step S509.

In the example illustrated in FIG. 5, since the NAN device 102 is in the doze state during DW1, the NAN device 102 has not received the subscribe message transmitted in step S509, and thus provides no response to this subscribe message (NO in step S404). The processing then proceeds to step S405.

In step S405, the NAN device 101 determines whether the NAN device 101 has received a synch beacon during this DW from the proxy client, i.e., from the NAN device 102 in the example illustrated in FIG. 5. In the example illustrated in FIG. 5, a synch beacon is received only from the NAN device 104. Therefore, the NAN device 101 determines that the NAN device 101 has not received a synch beacon from the proxy client (NO in step S405), and the processing proceeds to step S406. In step S406, the NAN device 101 responds as the proxy.

As the above-described result, in step S511, the NAN device 101 transmits a proxy service response as a publish message. This publish message includes information indicating that the NAN device 102 provides the print service and that the NAN device 102 is awake during DW0. When receiving this message, the NAN device 103 can recognize that the print service being provided by the NAN device 102 and the NAN device 103 can communicate with the NAN device 102 during DW0.

With respect to DW2 to DW15, steps similar to step S506 and step S507 are performed. Thus, detailed description thereof will be omitted. These steps are also omitted in the sequence diagram illustrated in FIG. 5.

In the next DW0, the NAN device 104 executes the processing of step S512 and then the NAN device 101 executes the processing of step S513, as with step S506 and step S507. In step S514, since the NAN device 103 sifts to a state that the NAN device 103 can communicate with the NAN device 102 during DW0, the NAN device 103 transmits a subscribe message, which is a message for a service search, to the NAN device 102. Then, in step S515, the NAN device 102 transmits a publish message notifying that the NAN device 102 provides the print service, as a service response. Since in step S514, the subscribe message is transmitted by unicast to the NAN device 102, the NAN device 101 does not perform the processing illustrated in FIG. 4.

In step S515, the NAN device 102 transmits the publish message including wireless-LAN setting information for using the print service. Specifically, the setting information includes various communication parameters for using the print service through direct wireless communication with the NAN device 102. For example, the setting information includes communication parameters for connection to the NAN device 102 by Wi-Fi Direct®, that include any of a service set identifier (SSID), an encryption key, an encryption algorithm, an authentication key, an authentication scheme, and channel information. Although not illustrated in the figures, the NAN device 103 performs the Wi-Fi Direct® connection to the NAN device 102 based on this information to actually use the print service.

The above-described processing enables the NAN device 101 to serve as the proxy of the NAN device 102 and notify the service. Accordingly, the NAN device 102 can inform the NAN device 103 that the NAN device 102 has the print service, while reducing power consumption by being in the doze state during DW1 to DW15.

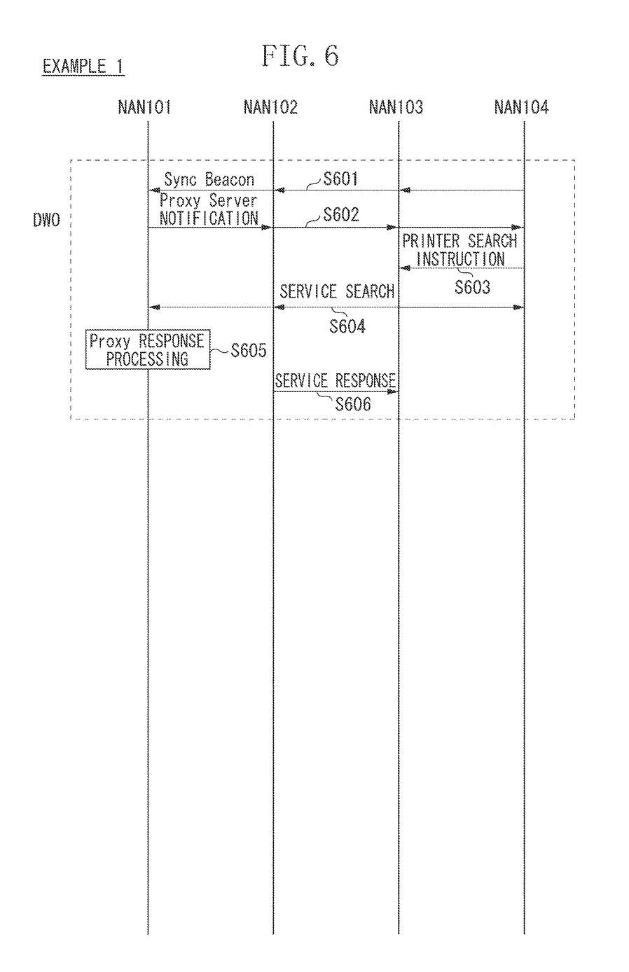

Next, a sequence in a case where the NAN device 101 receives a service search in a DW in which the NAN device 102 can respond will be described with reference to FIG. 6. FIG. 6 illustrates processing after step S505 in FIG. 5. In other words, this is a state that making a proxy request from the NAN device 102 to the NAN device 101 is completed, and the NAN device 101 can serve as the proxy of the NAN device 102 and notify a service.

The following description will be provided assuming that the user of the NAN device 103 has instructed the NAN device 103 to search for a printer during DW0, not during DW1, in FIG. 6. At the star of DW0, step S601 and step S602 are performed, as with step S502 and step S503. Step S603 and step S604 are performed, as with step S508 and step S509. In step S605, upon receipt of a subscribe message for searching for a service matching with the service corresponding to a proxy request, the NAN device 101 performs the processing of the flowchart in FIG. 4 to execute response processing, in a manner similar to step S510.

The description will be provided with reference to FIG. 4 again. In step S401, the NAN device 101 determines whether the current DW is DWn in which a proxy client can respond. In the example illustrated in FIG. 6, the current DW is DW0 and therefore, the NAN device 101 determines that the current DW is the DW in which the NAN device 102 can respond (YES in step S401). As a result, in step S402, the NAN device 101 decides not to respond as the proxy.

Based on the flowchart illustrated in FIG. 4, the NAN device 101 does not return a proxy service response, as a result of step S605. Instead, in step S606, the NAN device 102 provides a service response as a publish message, because the current DW is DW0 and the NAN device 102 can directly respond to the subscribe message transmitted in step S604. This is a message similar to the service response transmitted in step S515.

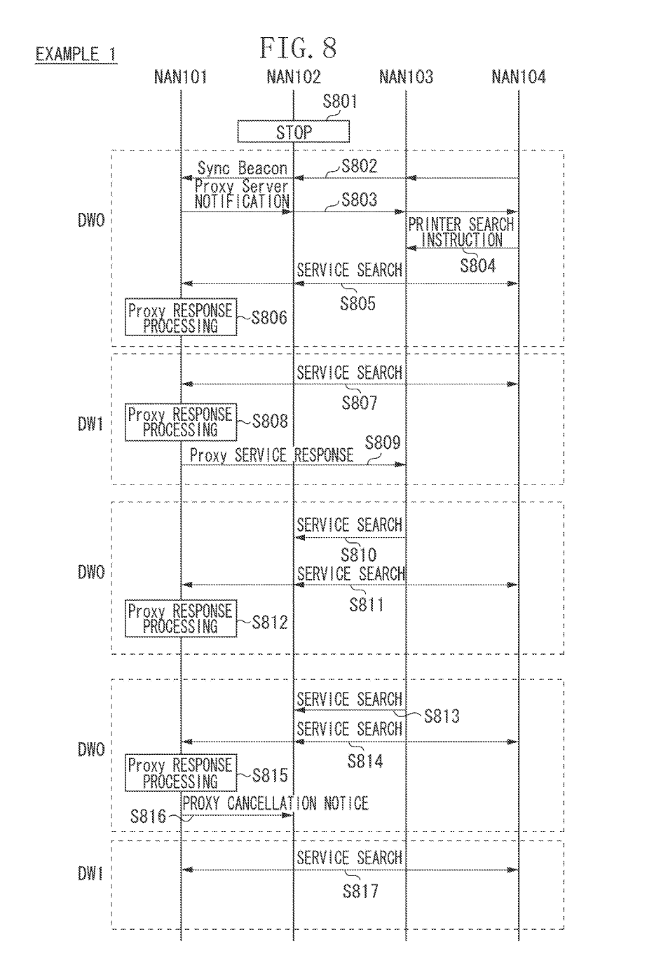

In this way, in the DW in which the proxy client can perform wireless transmission and reception, the NAN device 101 provides no response as the proxy, although the NAN device 101 is requested to serve as the proxy. This can prevent transmission of service responses duplicating each other. In other words, a message corresponding to the message in step S511 is not transmitted during DW0, and therefore, use of a wireless bandwidth can be reduced. In a case where detection is made that a proxy client provides no response even though the current DW is a DW in which the proxy client can perform wireless transmission and reception, proxy registration about this proxy client can be cancelled. A specific example of this case will be described below with reference to FIG. 8.

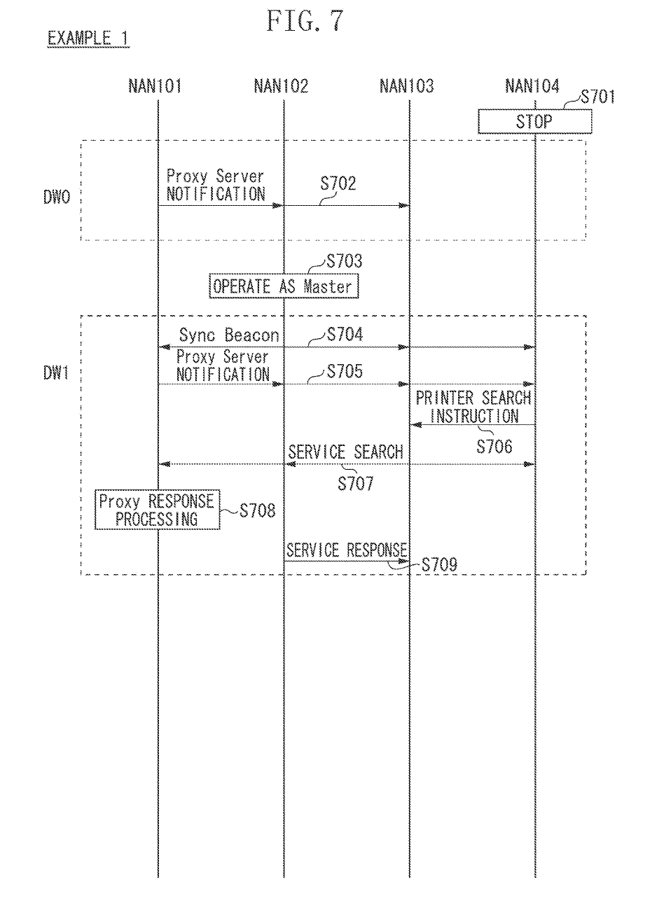

Next, a sequence in a case where the NAN device 102 is a beaconing device and receives a service search will be described with reference to FIG. 7. The beaconing device is a NAN device serving as a Master or Non-Master Sync, and transmits a synch beacon during a DW without fail. FIG. 7 will be described as processing following step S505 in FIG. 5. In other words, this is a state that making a proxy request from the NAN device 102 to the NAN device 101 is completed, and the NAN device 101 can serve as the proxy of the NAN device 102 and notify a service.

First, in step S701, the NAN device 104 serving as the Master stops operating as the Master, before DW0. Then, no NAN device operates as a Master during DW0 and thus, no device transmits a synch beacon. Therefore, when this DW0 ends, the NAN devices 101, 102, and 103 each perform role decision processing. As a result, in step S703, the NAN device 102 becomes a Master, and the NAN devices 101 and 103 each continue operating as the Non-Master Non-Sync. Before that, in step S702, the NAN device 101, during DW0, notifies that the NAN device 101 has a role as the proxy server.

In step S704, the NAN device 102 serving as the Master transmits a synch beacon during DW1. The processing of step S705 is performed in a manner similar to the processing of step S702. Subsequently, processing of step S706 and step S707 are performed, as with the processing of step S508 and step S509. In step S708, in a manner similar to the processing of step S510, upon receipt of a subscribe message for searching for a service matching with the service corresponding to the proxy request, the NAN device 101 performs the processing of the flowchart in FIG. 4 to execute response processing.

The description will be provided with reference to FIG. 4 again. In step S401, the NAN device 101 determines whether the current DW is a DWn in which a proxy client can respond. In the example illustrated in FIG. 7, the current DW is DW1 and therefore, the NAN device 101 determines that the current DW is not a DW in which the NAN device 102 can respond (NO in step S401). Next, in step S403, the NAN device 101 waits for receipt for a predetermined time. After waiting for the predetermined time, the NAN device 101 determines, in step S404, whether the proxy client has responded to the subscribe message (step S707) during this DW.

In the example illustrated in FIG. 7, the NAN device 102 has not responded to the subscribe message at this point (NO in step S404). Therefore, in step S405, the NAN device 101 determines whether the NAN device 101 has received a synch beacon from the NAN device 102 during this DW. In the example illustrated in FIG. 7, the NAN device 101 has received the synch beacon from the NAN device 102 in step S704 (YES in step S405). Thus, the processing proceeds to step S402. In step S402, the NAN device 101 decides not to respond as the proxy.

Based on the flowchart illustrated in FIG. 4, the NAN device 101 does not return a proxy service response, as a result of step S708. Instead, in step S709, the NAN device 102 provides a service response using a publish message, because the current DW is DW 0 and the NAN device 102 thus can directly respond to the subscribe message transmitted in step S707. This is a message similar to the service response transmitted in step S515.

In this way, in a case where the role of a proxy client in a NAN cluster is a beaconing device and the proxy client performs wireless transmission and reception during all DWs, the NAN device 101 provides no response as the proxy even though the NAN device 101 is requested to act as the proxy. This can prevent transmission of service responses duplicating each other. In other words, a message corresponding to the message in step S511 is not transmitted during the DW0 and therefore, use of a wireless bandwidth can be reduced.

Next, a sequence in the following case will be described: the NAN device 102 provides no response during a DW, which is notified as a DW in which the NAN device 102 is awake when a proxy request is made by the NAN device 102. This processing sequence will be described with reference to FIG. 8. FIG. 8 will be described as processing following step S505 in FIG. 5. In other words, making a proxy request from the NAN device 102 to the NAN device 101 is completed, and the NAN device 101 can notify a service as the proxy of the NAN device 102.

First, assume that, in step S801, the NAN device 102, before the DW0, stops operation as a NAN device without notifying the NAN device 101. Examples of such a case include a case in which the NAN device 102 leaves the NAN cluster 105 by moving out of the range of the NAN cluster 105 in which the NAN device 102 has been participating, and a case in which the function as a NAN device is turned off in the NAN device 102. Next, during the DW0, processing of step S802 and step S803 are performed, as with the processing of step S601 and step S602. Description of a synch beacon and a proxy server notification thereafter will be omitted. Then, processing of step S804 to step S806 are performed, as with the processing of step S603 to step S605. Here, in step S806, the current DW is DW0 and the NAN device 101 thus decides not to provide a service response as the proxy, in a manner similar to step S605. However, the NAN device 102 has already stopped and thus cannot respond to the service search in step S805, unlike step S606.

In step S807, the NAN device 103 broadcasts a message for a service search again during the next DW which is DW1, because a print service has not been discovered in step S805. Thus, processing of step S808 and step S809 are performed, as with the processing of step S510 and step S511. In step S810, the NAN device 103 transmits a subscribe message to the NAN device 102 after waiting until the DW0, in a manner similar to step S512. The NAN device 102 has however stopped and thus, no response to the subscribe message returns, unlike step S515. Therefore, in step S811, the NAN device 103 broadcasts a subscribe message for a service search again to find other print service.

In step S812, upon receipt of the subscribe message broadcasted in step S811, the NAN device 101 performs proxy response processing in a manner similar to step S806. In this case as well, the NAN device 101 does not respond as the proxy because the current DW is the DW0. Processing during the next DW1 are similar to the processing of steps S807 to S809, and therefore, are not described here and not illustrated in FIG. 8.

When the next DW0 starts, processing of step S813 and step S814 are performed, as with the processing of step S810 and step S811. In step S815, in response to the result of the previous step, the NAN device 101 performs proxy response processing in a manner similar to step S812. Since the proxy client has not responded twice, i.e., in step S806 and step S812, and therefore, based on the result of the determination in step S407 (YES in step S407), the processing proceeds to step S408. In other words, in step S407, the NAN device 101 determines whether the proxy client has not responded a predetermined number of times. In a case where the proxy client has not responded the predetermined number of times (YES in step S407), the processing proceeds to step S408.

In step S408, the NAN device 101 cancels the proxy registration about the proxy client. In the example illustrated in FIG. 8, the predetermined number of times that serves as a reference in step S407 is twice, but is not limited thereto. After the proxy registration is cancelled in step S408, the NAN device 101 transmits, in step S816, a proxy cancellation notice to the NAN device 102. Here, the NAN device 102 is not present in the NAN cluster 105 and therefore, this notice is not received by the NAN device 102. However, in a case where the NAN device 102 is still present in the NAN cluster 105, the NAN device 102 can recognize the cancellation of the proxy registration when receiving this notice.

Therefore, the NAN device 102 can transmit a request to another proxy server or increase the DWs in which the NAN device 102 is awake, so that a service can be easily discovered and the time taken before a discovery can be shortened. After cancelling the proxy registration, the NAN device 101 provides no response as the proxy of the NAN device 102, even if the NAN device 101 receives a print-service-related service search which is transmitted in step S817 in a manner similar to step S807.

In this way, in a case where a proxy client stops notifying service information for some reason, use of a wireless bandwidth due to continuation of unnecessary service proxy notification can be reduced.

### Other Embodiments

In the above described exemplary embodiment, the NAN device 101 operates as the proxy server that responds as the proxy, for notification of the service provided by the NAN device 102. However, what is transmitted by the proxy function is not limited to the information of a service that can be provided. For example, the NAN device 101 can receive a request to search for a service from another device, and can search for the service as a proxy of another device.

In this case, for example, the NAN device 101 can search for the service, by transmitting a subscribe message as the proxy of another device, and receiving a publish message in response to the subscribe message. The NAN device 101 can wait for a publish message transmitted (e.g., voluntarily) by yet another device, without transmitting a subscribe message. In either case, the NAN device 101 can notify a search result to a device, which has requested a proxy search for a service, during a DW in which this device can receive a wireless signal.

The predetermined time for waiting for reception in step S403 is not necessarily a fixed length of time. For example, this waiting time can be shortened, in a case where the Master Rank of the NAN device 102 serving as the proxy client is high, because the NAN device 102 is highly likely to become the Master in such a case. Reducing the waiting time enables a proxy response to be made more quickly, so that a service discovery period can be reduced.

In the above-described exemplary embodiment, the NAN device 101 receives a proxy request only from the NAN device 102, but may receive a proxy request from one or more of other NAN devices.

A program, which implements the function of the above-described exemplary embodiment, can be supplied to a system or apparatus via a network or storage medium. One or more computers (or CPUs or MPUs) of the system or apparatus then read and execute the program.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-180634, filed Sep. 15, 2016, which is hereby incorporated by reference herein in its entirety.

What is claimed is:

1. A communication apparatus comprising:
a communication unit configured to transmit and receive wireless signals in a period with a predetermined length and occurring at a predetermined time interval;
a processing unit configured to process at least one of transmission or reception of a wireless signal in the period as a proxy of a specific communication apparatus belonging to a group of communication apparatuses that are in synchronization during the period; and
a decision unit configured to decide, based on whether a period in which the processing unit performs the proxy processing is a period in which the specific communication apparatus transmits or receives wireless signals, whether to perform proxy processing by the processing unit.

2. The communication apparatus according to claim 1, wherein the decision unit decides not to perform the proxy processing in a case where the period in which the processing unit performs the proxy processing is the period in which the specific communication apparatus transmits or receives wireless signals, and decides to perform the proxy processing in a case where the period in which the processing unit performs the proxy processing is not the period in which the specific communication apparatus transmits or receives wireless signals.

3. The communication apparatus according to claim 1, further comprising a determination unit configured to determine a period in which the specific communication apparatus transmits or receives wireless signals from among a plurality of periods.

4. The communication apparatus according to claim 3, further comprising:
an acquisition unit configured to acquire, from the specific communication apparatus, information indicating the period, from among the plurality of periods, in which the specific communication apparatus transmits or receives wireless signals,
wherein the determination unit makes a determination using the acquired information.

5. The communication apparatus according to claim 3, further comprising:
a reception unit configured to, during the period, receive from the specific communication apparatus a wireless signal notifying that a current period is the period,
wherein the determination unit determines, from among the plurality of periods, that a period in which the reception unit receives the wireless signal is the period in which the specific communication apparatus transmits and receives wireless signals.

6. The communication apparatus according to claim 1, wherein the wireless signal includes a signal indicating a service to be provided by another communication apparatus.

7. The communication apparatus according to claim 1, wherein the wireless signal includes a signal for searching for a service to be provided by another communication apparatus.

8. The communication apparatus according to claim 1, wherein the period is a discovery window of Wi-Fi® Neighbor Awareness Networking.

9. The communication apparatus according to claim 1, wherein the group of communication apparatuses is a NAN cluster of Wi-Fi® Neighbor Awareness Networking.

10. The communication apparatus according to claim 1, wherein the specific communication apparatus is a communication apparatus that requested the communication apparatus to perform proxy processing.

11. A communication method comprising:
transmitting or receiving wireless signals in a period with a predetermined length and occurring at a predetermined time interval;
processing at least one of transmission or reception of a wireless signal in the period as a proxy of a specific communication apparatus belonging to a group of communication apparatuses that are in synchronization during the period; and
deciding, based on whether a period in which the proxy processing is performed is a period in which the specific communication apparatus transmits or receives wireless signals, whether to perform proxy processing.

12. A non-transitory computer-readable storage medium storing a program for causing a communication apparatus to execute a communication method, the communication method comprising:
transmitting or receiving wireless signals in a period with a predetermined length and occurring at a predetermined time interval;
processing at least one of transmission or reception of a wireless signal in the period as a proxy of a specific communication apparatus belonging to a group of communication apparatuses that are in synchronization during period; and
deciding, based on whether a period in which the proxy processing is performed is a period in which the specific communication apparatus transmits or receives wireless signals, whether to perform proxy processing.
